(19) United States
(12) Patent Application Publication
(10) Pub. No.: US 2018/0098663 A1
(43) Pub. Date: Apr. 12, 2018

(54) PACKAGED PRE-SOAKED GRILLING PLANKS

(71) Applicants: Eric J. Wangler, Mendon, NY (US); David P. Prior, Rochester, NY (US)

(72) Inventors: Eric J. Wangler, Mendon, NY (US); David P. Prior, Rochester, NY (US)

(21) Appl. No.: 15/836,231

(22) Filed: Dec. 8, 2017

Related U.S. Application Data
(63) Continuation-in-part of application No. 14/966,877, filed on Dec. 11, 2015.
Application No. 14/966,877 is a continuation-in-part of application No. 14/700,980, filed on Apr. 30, 2015, now abandoned.
(60) Provisional application No. 62/104,152, filed on Jan. 16, 2015.

(51) Int. Cl. A47J 37/07; B65D 81/22; B65D 30/22; B65B 5/04; B65B 7/02; B65B 31/02

(52) U.S. Cl. CPC A47J 37/0786; B65D 81/22; B65B 31/024; B65B 5/045; B65B 7/02; B65D 31/12

(57) ABSTRACT

A grilling plank assembly includes a substantially liquid impervious bag, a grilling plank positioned within the bag, a soaking liquid positioned within the bag of a quantity to substantially immerse the plank therein, and the bag having a rupturable seal to secure the plank and liquid therein and to enable selective opening to remove the plank therefrom and thereafter resealing of the bag. The bag may be provided with more than one planks, with separator devices separating the planks within the bag.

### CROSS-REFERENCE TO RELATED APPLICATIONS

This is a Continuation-in-Part of U.S. patent application Ser. No. 14/966,877 for PRE-SOAKED PACKAGED WOODEN PLANKS AND METHODS THEREFOR which was filed on Dec. 11, 2015, published as U. S. Publication 2016/0206150 on Jul. 21, 2016, and incorporated herein by reference in its entirety. This application also claims priority from U.S. patent application Ser. No. 14/700,980 for SELF-STANDING CONTAINER FOR PRE-SOAKING GRILLING PLANKS which was filed on Apr. 30, 2015, which is incorporated herein by reference in its entirety, and which was co-pending with application Ser. No. 14/966,877. This application also claims priority from U.S. Provisional Application No. 62/104,152, filed Jan. 16, 2015, which is incorporated herein by reference in its entirety.

### BACKGROUND OF THE INVENTION

The present invention is generally directed to improvements in plank cooking devices and, more particularly, to a packaged cooking plank immersed in a soaking liquid and sealed in a liquid impervious bag.

Cooking food on hot wooden planks is a well known method of preparing food that is becoming more popular. Wood plank cooking arises from the Pacific Northwest Native art of plank grilling, an ancient tradition of cooking sides of fresh fish, specifically salmon, on alder wood or cedar. Plank grilling of fish and other foods on sections of soaked aromatic woods set over a grill is a very complex culinary experience. As the food cooks, essentially basting itself in its own oils and juices, the wood smolders, creating fragrant wood smoke which contacts and interacts with the food to achieve a layering of flavors not found in other forms of cooking.

In order to properly use a wooden plank to prepare and cook food, the plank must be thoroughly soaked in water or other liquid, such as juice, cider, broth or wine, for anywhere from about twenty minutes to six hours or longer. Soaking of the plank delays ignition of the wood whereby the wood creates smoke and other vapors which flavor the food cooked on the plank. For shorter time periods, typically the plank will be held under running water in a sink or placed in a pan or other container of water, resulting in under-soaking which can create fire hazards. For longer soaking periods, typically the plank is placed in a pan or bucket and some weight is placed on the wood to keep it submerged. This may result in uneven soaking as one end of the board lifts up, or even an entire side of the board if the weight holding the board down shifts entirely. Additionally, the area of the plank underneath the weight may not absorb liquid or flavors effectively. Proper soaking requires even soaking for the entire time period, so as to produce the optimal amount of smoke for food cooking and flavor without the risk of a fire. Pre-soaked wood that can be stored on the shelf for a period of time is more efficient and saves time by avoiding the soaking process entirely.

### SUMMARY OF THE INVENTION

The present invention provides a device for supporting and flavoring food during cooking, grilling, baking, roasting, broiling, or the like.

An embodiment of the present invention provides a pre-soaked grilling plank assembly comprising a substantially liquid impervious bag; a grilling plank positioned within the bag; a soaking liquid positioned within the bag of a quantity to substantially immerse the plank therein; and the bag having a rupturable seal to secure the plank and liquid therein and to enable selective opening of the bag to facilitate removal of the plank therefrom. The assembly may include a second grilling plank positioned within the bag and immersed within the liquid a reseal structure formed within the bag to enable selective resealing of the bag after removal of one of the planks therefrom. The bag may a separator positioned between the planks to separate the planks within the bag. The separator may include a separator wall positioned between the planks to separate the planks within the bag. Alternatively, the separator may be formed by a weld line between the front wall and the back wall of the bag.

The bag may be formed of a flexible, substantially liquid impervious polymer film. In an embodiment of the plank assembly, the bag is formed of a material which is impervious to an extent whereby the bag loses no more than 0.01 percent of the liquid weight over a period of about two years. Alternatively, the bag may be formed of a material which is impervious to an extent whereby the bag loses none of the liquid over a period of about two years. In an embodiment of the plank assembly, a quantity of soaking liquid within the bag has a liquid weight equal to the plank weight of each plank within the bag.

In embodiments of the plank assembly, the liquid may include water, broth, juice, or the like in which the wooden plank is immersed to pre-soak the plank. The liquid may include a preservative. The wooden plank may be made of a wood, such as oak, maple, pine, cedar, alder, cherry, hickory, ash, apple, pear, or the like. The wooden plank is pre-soaked in the liquid, such that the wooden plank smolders during the cooking process, thereby smoking the food. The pre-soaked wooden plank is sealed within the package, so that it will not dry out before use by the user.

In one embodiment, a device for supporting and flavoring a food during cooking is provided and includes a packaging structure with an interior and a wooden plank that is removably located within the packaging structure interior, wherein the wooden plank is substantially immersed in a quantity of a liquid.

In a further embodiment, the device includes at least one additional wooden plank positioned within the package and submerged or immersed in the liquid therein. The package may include a separator to separate one plank within the package from another plank therein.

In a further embodiment, the packaging structure is one of water-resistant, waterproof, and air-resistant. The package is preferably formed of a food-safe material, such as a plastic or polymer, paper, metal foil or the like and may include laminated combinations of such materials. The package may be formed of a shrink-wrap or heat shrinkable material. The packaging structure is adapted to substantially prevent loss of liquid, so as to substantially prevent the wooden plank from drying out.

In a further embodiment, the wooden plank is at least partially permeated with the liquid. In another further embodiment, the wooden plank includes a quantity of the liquid sufficient to suppress at least some combustion thereof. In still another further embodiment, the wooden plank includes a quantity of the liquid sufficient to cause the wooden plank to smolder when placed over a fire. In yet another further embodiment, the wooden plank is adapted for cooking a food on a gas grill, a charcoal grill, a wood fire or in the oven.

An embodiment of the invention includes a method of packaging a grilling plank comprising the steps of: providing a substantially liquid impervious bag; positioning a grilling plank within the bag; positioning a grill soaking liquid within the bag of a quantity to substantially immerse the plank therein; and providing a rupturable seal on the bag to secure the plank and liquid therein and to enable selective opening of the bag to facilitate removal of the plank therefrom.

In a further embodiment, a method of making a device for supporting and flavoring a food during cooking is provided, the method including the steps of providing a wooden plank and a quantity of liquid; submerging the wooden plank in the quantity of liquid for a period of time, whereby at least some of the liquid penetrates the wooden plank; and packaging the wooden plank in a packaging structure adapted to substantially prevent evaporation of the liquid that penetrated the wooden plank.

In a further embodiment, the step of submerging the wooden plank in the quantity of liquid includes soaking the wooden plank in the quantity of liquid.

In a further embodiment, the step of providing a quantity of liquid includes providing a quantity of water. In a still further embodiment, the step of providing a quantity of water includes providing a flavoring.

In a further embodiment, the step of packaging the wooden plank includes providing the packaging structure. In a still further embodiment, the packaging structure is a re-sealable bag, such as a plastic bag.

In a further embodiment, a method of making a pre-soaked wooden plank for supporting and flavoring a food during cooking is provided, including the step of saturating a plurality of pre-cut wooden planks.

In a further embodiment, the step of saturating the plurality of pre-cut wooden planks includes at least one of static batch vat soaking, large batch steam pressure chamber treatment and serpentine conveyance through a tank of liquid.

In a further embodiment, the method includes placing the soaked planks in a oxygen barrier polymer bag or polybag; placing the polybags with the planks in a vacuum chamber; removing the excess air from the polybag; and heat sealing the polybag.

In a further embodiment, the method includes placing the soaked planks onto a conveyor with two rolls of barrier film above and below the plank; transporting the planks into an automated scaling device wherein the bag is sealed on three side; drawing a vacuum; and sealing the fourth side.

In a further embodiment, the method includes purging ambient air from the bag with gas prior to vacuum and final seal, whereby preservation of the plank is extended by minimizing bacterial growth.

In a further embodiment, the method is automated.

In a further embodiment, each plank is individually packages and then several packages are enclosed in a retail appropriate package for sale.

In a further embodiment, the method includes adding natural or artificial flavor to the liquid for soaking the planks.

Various objects and advantages of the present invention will become apparent from the following description taken in conjunction with the accompanying drawings wherein are set forth, by way of illustration and example, certain embodiments of this invention.

The drawings constitute a part of this specification and include exemplary embodiments of the present invention and illustrate various objects and features thereof.

### BRIEF DESCRIPTION OF THE DRAWINGS

FIG. 1 is a perspective view of pre-soaked wooden grilling planks supporting food on a charcoal grill.

FIG. 2 is a front elevational view of a grilling plank immersed in a soaking liquid and sealed within a bag.

FIG. 3 is a somewhat enlarged cross-sectional view of the bag, taken on line 3-3 of FIG. 2, and illustrating two grilling planks in a tandem relation and separated by a film wall within the bag.

FIG. 4 is a front elevational view of a bag with a seal torn away and showing a grilling plank being withdrawn from the bag.

FIG. 5 is a front elevational view of a pair of grilling planks positioned in side-by-side relation and immersed in a soaking liquid within a bag and separated by a weld between front and back walls of the bag.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

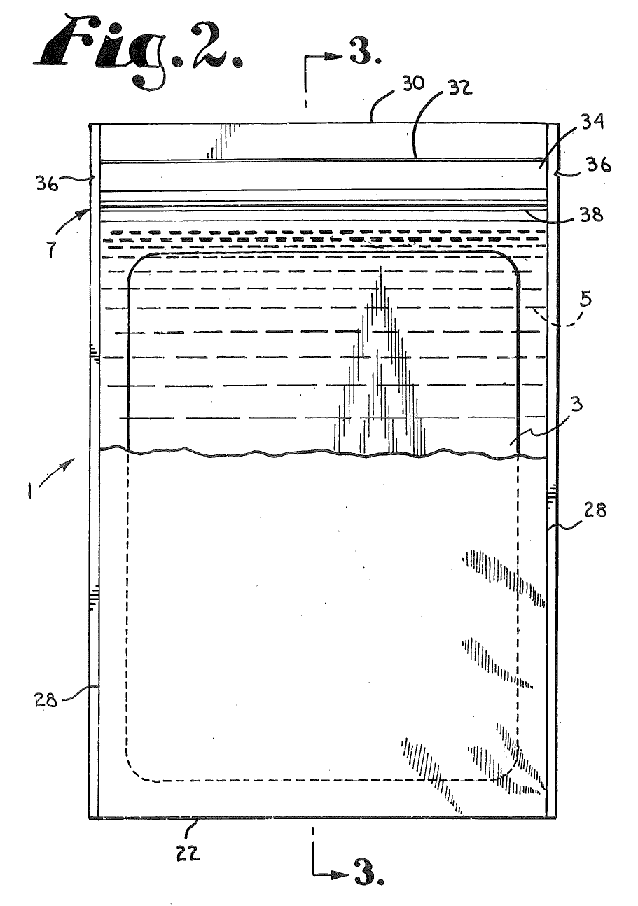

The reference numeral 1 (FIGS. 2-5) generally designates a packaged, pre-soaked grilling plank assembly embodying the present invention. The assembly 1 generally includes a grilling plank 3 immersed within a soaking liquid 5 sealed within a substantially liquid impervious package or bag 7.

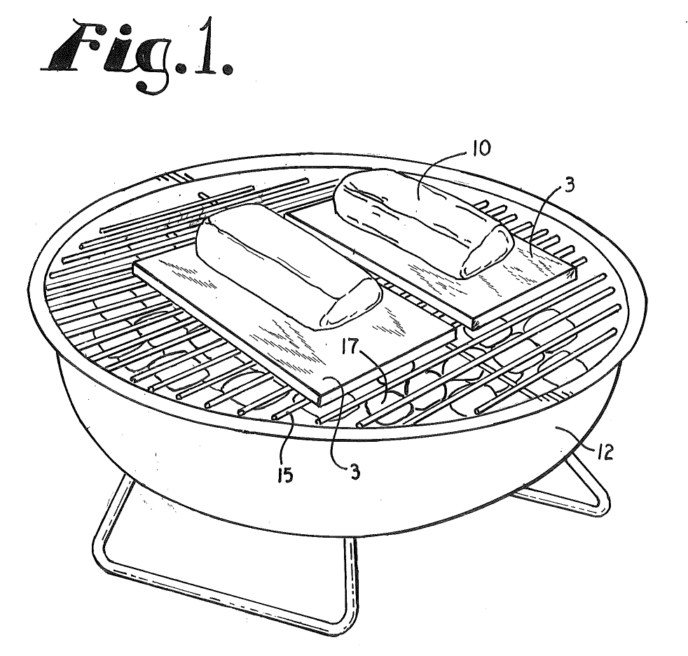

FIG. 1 illustrates use of the grilling plank 3 as a device for supporting and optionally flavoring a food during cooking. As shown in FIG. 1, the wooden plank 3 is adapted to support a quantity, portion, item, piece, or the like of a food 10 during cooking, such as cooking over a grill 12. In the illustrated embodiment, the grill 12 includes a grate 15 that receives the wooden plank 3 thereon and supports the wooden plank 3 above a heat source 17 such as, but not limited to, a charcoal fire, a gas fire, or the like. Alternatively, the wooden plank 3 can be placed onto a baking sheet into a pan, and the cooking can be performed by baking in an oven, cooking over an open camp fire, or the like. Such cooking methods are commonly referred to as “planking” or “grilling on a wooden plank.” It is foreseen that the wooden plank 3 can be replaced by a wooden skewer (not shown).

In some circumstances, one, two, three, four, five or more wooden planks 3 may packaged together for sale to the end user. The package or bag 7 includes the soaking liquid 5 whereby the planks 3 are immersed or submerged therein and will be soaked prior to purchase by the user.

The packaging structure or bag 7 is substantially liquid impervious, and may be considered water-resistant or waterproof. The terms “water-resistant” and “waterproof,” as used herein, are broad terms and are used in its ordinary sense, including, without limitation, being relatively unaffected by water, such as resisting the egress of water from unopened packaging such as, but not limited to, egress by evaporation, during storage. Water-resistant and waterproof packaging as is known in the art. The bag 7 is also substantially gas impervious or air-resistant. The term “air-resistant,” as used herein, is a broad term and is used in its ordinary sense, including, without limitation, being relatively unaffected by air, such as resisting the ingress or egress of air from unopened packaging during storage. Air-resistant packaging is known in the art. In some embodiments, the packaging structure is adapted to substantially prevent loss of liquid, so as to substantially prevent the wooden plank 3 from drying out.

In an embodiment of the plank assembly 1, the bag 7 is formed of a material which is impervious to an extent whereby the bag loses no more than 0.01 percent of the weight of the liquid in the bag over a period of about two years. In another embodiment of the assembly 1, the bag 7 loses none of the liquid over a period of about two years. In some embodiments of the assembly 1, the weight of the liquid 5 is approximately equal to the weight of the plank or planks 3 positioned within the bag 7.

The packaging structure is manufactured from a food-safe material including, but not limited to, plastic or polymer, paper, and metal foil or combinations or laminations thereof. The term “food-safe,” as used herein, is a broad term and is used in its ordinary sense including, without limitation, being suitable for contact with food as defined by described in the Code of Federal Legislation (CFR): 21 CFR 174-21 CFR 190. Food contact materials include but are not limited to plastics, rubber, paper, coatings and metals. For example, in many cases a combination of such materials is used to fabricate a package structure. For example a carton box for juices can include (from the inside to the outside): plastic layer, aluminum, paper, printing and top coating. In some circumstances, the packaging structure may be a shrink-wrap or heat shrinkable material.

The wooden plank 3 can be made using any type of wood, so long as the wood is a food-safe wood (i.e., not pressure treated wood with added chemicals or plywood with adhesives therein). However, wood plank grilling is usually performed using an aromatic wood, such as various hardwoods, evergreen woods, or fruit woods. Accordingly, in some embodiments, the wooden plank 3 may be oak wood, maple wood, pine wood, cedar wood, alder wood, hickory wood, ash wood, cherry wood, apple wood, pear wood, or the like. The wooden plank 3 should not be made from woods that are not food-safe, such as wood derived from plants that are poisonous, toxic, or noxious to humans or wood that has been soaked or coated in, or injected with, poisonous, toxic, or noxious chemicals or substances.

In some circumstances, the wooden plank 3 may be treated to enhance flavor of the food during cooking. For example, the wooden plank 3 can be roasted, coated with one or more herbs, spices, and/or salt, or soaked in a flavoring liquid such as, but not limited to, flavored water, juice, wine, cider, broth, or the like. Such flavoring techniques are known in the art.

Generally, the wooden plank 3 is sized and shaped, or otherwise adapted, to support food during cooking. Common plank shapes include elongated, flat planks of wood. In some circumstances, the plank 3 may be circular or an oval, and is typically generally short and flat, with a width and length sufficient to support a desired quantity of food 10. In other circumstances, the planks 3 may have short, flat rectangular or polygonal shapes. Typically, the plank 3 is shaped to hold a specific quantity of food 10, such as a fish fillet, a chicken breast, a steak, a hamburger patty, or the like. In some circumstances, the plank 3 may be sized to support multiple pieces of food 10. In some circumstances, the plank 3 may be sized and shaped to be received by a coordinating platter or pan (not shown) such as, but not limited to, a decorative serving platter. Such platters and pans may or may not be suitable for use in the oven.

As noted above, the wooden plank 3 is soaked in a liquid 5. Generally, the wooden plank 3 is at least partially permeated or infused with the liquid 5. Accordingly, the liquid 5 diffuses a distance into the plank 3. The distance that the liquid 5 diffuses into the plank 3 depends upon several factors such as, but not limited to, the type of wood used, the type of liquid 5 used, the length of the soaking time, the temperature and the pressure. In some embodiments, the liquid 5 diffuses into the wood a distance of about one-sixteen of an inch, about one-eighth of an inch, about one-fifth of an inch, about one-fourth of an inch, about one-third of an inch, about one-half of an inch, about two-thirds of an inch, about three-fourths of an inch, about an inch, or farther, wherein the distance is measured from the nearest surface of the wooden plank 3.

The wooden planks 3 can be soaked for various periods, durations or lengths of time from about 20 minutes or less up to about 120 minutes or longer. For example, the wooden planks 3 can be soaked for about 30 minutes, about 40 minutes, about 50 minutes, about 60 minutes, about 70 minutes, about 80 minutes, about 90 minutes, about 100 minutes or about 110 minutes. As sealed within the bag 7, the plank 3 is immersed or submerged within the liquid 5 for an indefinite period of time, whereby the plank 3 is substantially saturated with the liquid 5.

Generally, the wooden plank 3 is soaked such that it includes a quantity of the liquid 5 that is sufficient to suppress at least some combustion thereof. For example, the quantity of liquid included in the wooden plank 3 is sufficient to suppress at least some combustion of the wooden plank 3 when the food is being cooked thereon, such as when being grilled. In some embodiments, the wooden plank 3 includes a quantity of the liquid sufficient to cause the wooden plank 3 to smolder when placed over a fire. When the wooden plank 3 smolders, a fragrant smoke is produced. The fragrant smoke generally permeates and flavors the food 10 being cooked on the wooden plank 3.

Generally, the wooden plank 3 is adapted for cooking a piece of food 10 on a grill 12, such as a gas or charcoal grill, on a wood fire, or in the oven, such as is known in the art.

A variety of liquids 5 can be used to soak the wooden plank 3. Some liquids 5, such a water, only moisten the wooden plank 3 and do not substantially impart flavors thereto. Some liquids 5, such as juice, cider or wine impart flavors to the wooden plank 3. Liquids 5 that impart flavor to the wooden plank 3 can impart flavor to the food 10 that is cooked on the wooden plank 3, such as by the smoke created as the plank 3 burns, chars, smoked or smolders, such as is known in the art. In some circumstances, the liquid 5 includes a flavoring, such as herbs, spices, salts, vinegar, juice or a flavor extract. In some circumstances, the liquid 5 includes a preservative. It is foreseen that a preservative may be included in the soaking liquid 5, to preserve the soaked wooden plank 3 for a period of time, such as the storage time, before the end of which the plank 3 should be used by the end user.

In another embodiment, wooden skewers (not shown) are used instead of wood planks 3. The skewers, which can be fabricated similarly to the planks 3 using any wood or method described herein, are packaged with a soaking liquid, such as is described herein. Packaged pre-soaked skewers provide convenience and time savings by providing the user with a readily available, shelf-stable source of skewers that the user does not have to soak prior to use.

In another embodiment, a method of making a device for supporting and flavoring a food 10 during cooking is provided. The method includes the steps of providing a wooden plank 3 and a quantity of liquid 5, such as is described above; submerging the wooden plank 3 in the quantity of liquid 5 for a period of time, such as is described above, whereby at least some of the liquid 5 penetrates the wooden plank 3; and packaging the wooden plank 3 immersed within the liquid 5 in a packaging structure 7 adapted to substantially prevent evaporation of the liquid 5 that penetrates and surrounds the wooden plank 3 therein.

In some circumstances, the step of saturating the plurality of pre-cut wooden planks 3 includes at least one of static batch vat soaking, large batch steam pressure chamber treatment and serpentine conveyance through a tank of liquid 5, such as is known in the art.

In some embodiments, the method is automated. In other embodiments, some or all steps of the method are performed by hand.

In a further embodiment, each plank 3 is individually package and then several packages of planks 3 are enclosed in a retail appropriate package for sale to the consumer or end user.

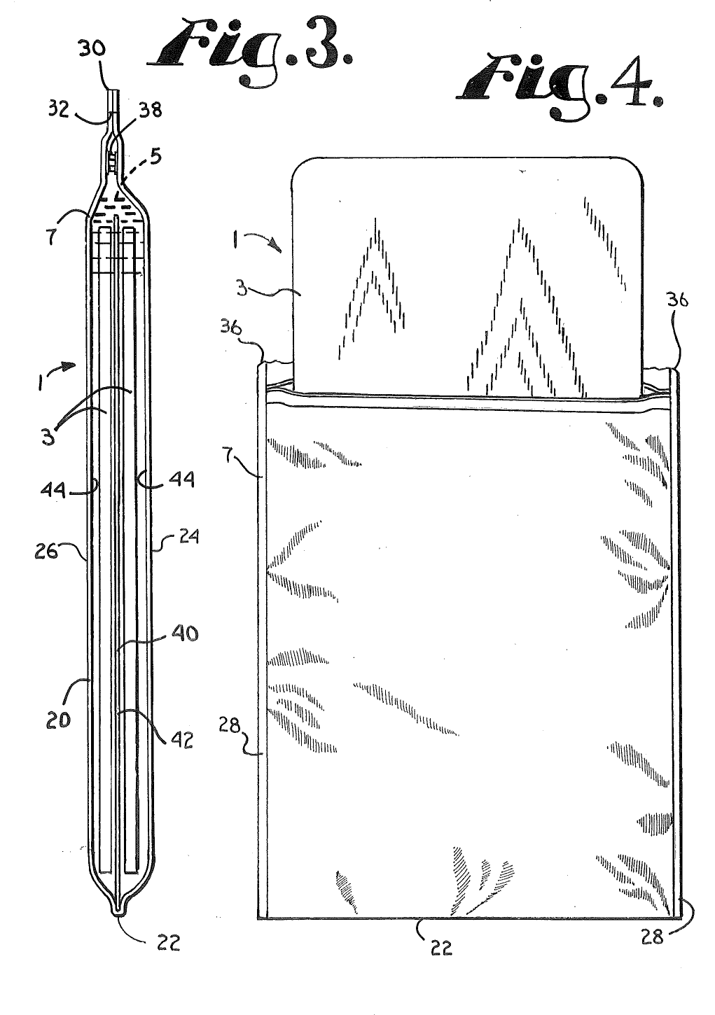

FIGS. 2-5 illustrate embodiments of the packaged pre-soaked grilling plank assembly 1 according to the present invention. The assembly 1 generally includes the grilling plank 3 substantially immersed or submerged within the soaking liquid 5 and sealed within the package or bag 7. Referring to FIG. 3, the illustrated bag 7 is formed by a sheet 20 of a polymer film 20 which is folded at a bottom end 22 of the bag 7 to form a front wall 24 and a back wall 26. Side edges 28 (FIG. 2) of the sheet 20 are sealingly joined, as by welding. Top ends 30 of the walls 24 and 26 are sealing joined, as by welding at a seal line 32, after the planks 3 and liquid 5 are positioned within the bag 7.

The sheet 20 may be formed of a polymer film such as BoPET (biaxially-oriented polyethylene terephthalate), a polyester film made from stretched polyethylene terephthalate (PET) and used in the assembly 1 for its liquid, gas, and aroma barrier properties. Mylar (trademark of E. I. du Pont de Nemours and Co. www.dupont.com) is a well-known brand of a BoPET film. The sheet 20 may be laminated with a foil or may be metalized by a thin layer of metal, such as aluminum. Alternatively, other materials could be used for the sheet 20. It is foreseen that the film sheet 20 could be laminated with another type of polymer, a type of paper, or the like. It is also foreseen that the bag 7 could be a transparent film.

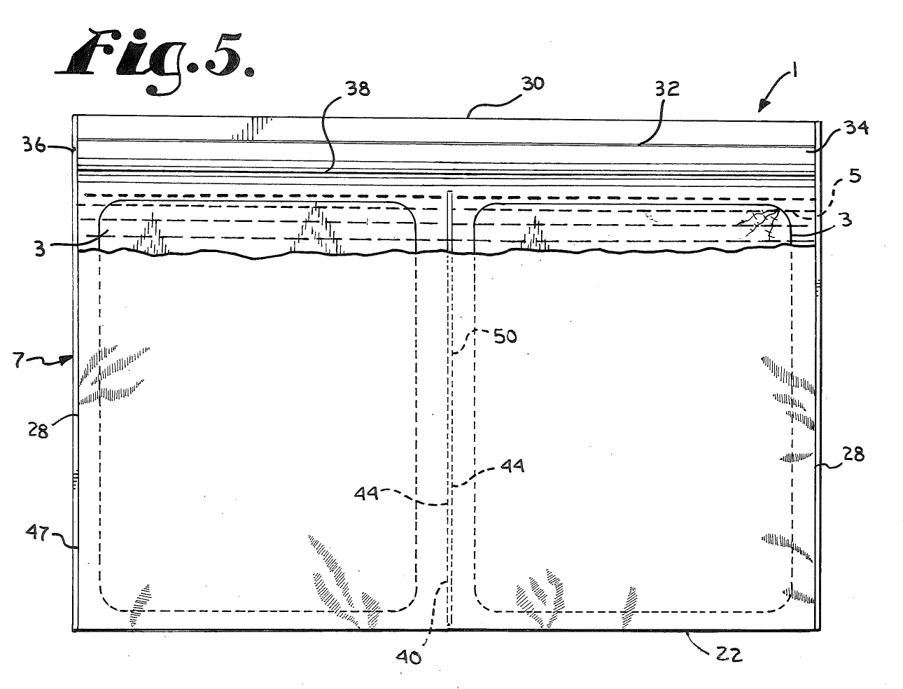

In order to remove a plank 3 from the bag 7 for using in grilling, the bag 7 must be opened. The bag 7 may be cut, as with a knife or scissors or, alternatively, a top or upper end section 34 of the bag may be torn off the bag 7. The illustrated bag 7 is provided with tear notches 36 to initiate and facilitate tearing the top section 34 from the bag 7. FIG. 4 illustrates the bag 7 with the top section 34 torn off to enable the plank 3 to be withdrawn from the bag 7.

The bag 7 may be made reusable after opening by providing a reseal mechanism or device 38 on the top end section 34 of the bag 7. The illustrated reseal device 38 is a sliderless plastic zipper, such as a Ziploc brand of zipper (trademark of S. C. Johnson & Son, Inc. www.ziploc.com). Other types of reseal devices 38 may incorporate such a zipper with a slider. Alternatively, other types of reseal devices 38 may be provided on the bag 7. When the original plank 3 is removed from the bag 7 for use in grilling, the bag 7 may be refilled with a soaking liquid 5 and a new plank 3 may be immersed in the liquid 5, and the bag 7 may be sealed using the reseal device 38 and stored for future use.

As shown in FIG. 3, the plank assembly 1 may be provided with more than one plank 3 enclosed in the bag 7. The bag 7 may be provided with a plank separator 40 to facilitate removal of the planks 3 one at a time. Such a separator 40 may be provided as a separator wall 42 shown in FIG. 3. The illustrated separator wall 42 may be welded to the film sheet 20 at the bottom end 22 and on the side edges 28 within the bag 7 to form separate plank pockets or compartments 44 to receive the planks 3. When the assembly 1 is formed, care must be taken to fill the bag 7 with enough liquid 5 to substantially immerse both or all of the planks 3 within the bag 7.

While FIG. 3 shows a pair of planks 3 positioned in front-to-back or tandem relation, FIG. 5 shows a pair of planks 3 in side-by-side relation within a widened bag 47. The bag 47 is substantially similar to the bag 7 except that the bag 47 is wider than the bag 7 to accommodate two planks 3 is side-by side relation. The bag 47 may provided with a plank separator 40 to form side-by-side plank pockets 44. The illustrated plank separator 40 is a separator weld line 50 extending from near a bottom end 22 of the bag 47 to near a top section 34 of the bag. When the assembly 1 is formed using the bag 47, the bag must be filled with enough soaking liquid 5 to substantially immerse the planks 3 therein. In other respects, the assembly 1 formed with the bag 47 is substantially similar to the assembly 1 formed with the bag 7.

It is to be understood that while certain forms of the present invention have been illustrated and described herein, it is not to be limited to the specific forms or arrangement of parts described and shown.

What is claimed and desired to be secured by Letters Patent is:

1. A pre-soaked grilling plank assembly comprising:
(a) a substantially liquid impervious bag;
(b) a grilling plank positioned within the bag;
(c) a soaking liquid positioned within the bag of a quantity to substantially immerse the plank therein; and
(d) the bag having a rupturable seal to secure the plank and liquid therein and to enable selective opening of the bag to facilitate removal of the plank therefrom.

2. An assembly as set forth in claim 1 and including:
(a) a second grilling plank positioned within the bag and immersed within the liquid; and
(b) a reseal structure formed within the bag to enable selective resealing of the bag after removal of one of the planks therefrom.

3. An assembly as set forth in claim 1 and including:
(a) a second grilling plank positioned within the bag and immersed within the liquid; and
(b) a separator positioned between the planks to separate the planks within the bag.

4. An assembly as set forth in claim 1 and including:
(a) a second grilling plank positioned within the bag and immersed within the liquid; and
(b) a separator wall positioned between the planks to separate the planks within the bag.

5. An assembly as set forth in claim 1 wherein the bag has front and back walls and including:
(a) a second grilling plank positioned within the bag and immersed within the liquid; and
(b) a separator positioned between the planks to separate the planks within the bag formed by a weld line between the front wall and the back wall of the bag.

6. An assembly as set forth in claim 1 and including:
(a) the bag being formed of a flexible, substantially liquid impervious polymer film.

7. An assembly as set forth in claim 1 wherein:
(a) the liquid has a liquid weight; and
(b) the bag is formed of a material which is impervious to an extent whereby the bag loses no more than 0.01 percent of the liquid weight over a period of about two years.

8. An assembly as set forth in claim 1 wherein:
(a) the bag is formed of a material which is impervious to an extent whereby the bag loses none of the liquid over a period of about two years.

9. An assembly as set forth in claim 1 wherein:
(a) the liquid has a liquid weight and the plank has a plank weight; and
(b) the liquid weight of the liquid within the bag is approximately equal to the plank weight of the plank within the bag.

10. A pre-soaked grilling plank assembly comprising:
(a) a substantially liquid impervious bag;
(b) a first grilling plank and a second grilling plank positioned within the bag;
(c) a separator positioned between the planks to separate the planks within the bag;
(d) a soaking liquid positioned within the bag of a quantity to substantially immerse the planks therein;
(d) the bag having a rupturable seal to secure the planks and liquid therein and to enable selective opening of the bag to facilitate removal of a plank therefrom; and
(e) a reseal structure formed within the bag to enable selective resealing of the bag after removal of one of the planks therefrom.

11. An assembly as set forth in claim 10 wherein:
(a) the separator is formed by a separator wall positioned between the planks to separate the planks within the bag.

12. An assembly as set forth in claim 10 wherein the bag has front and back walls wherein:
(a) the separator is formed by a weld line between the front wall and the back wall of the bag.

13. An assembly as set forth in claim 10 and including:
(a) the bag being formed of a flexible, substantially liquid impervious polymer film.

14. An assembly as set forth in claim 10 wherein:
(a) the bag is formed of a material which is impervious to an extent whereby the bag loses none of the liquid over a period of about two years.

15. An assembly as set forth in claim 10 wherein:
(a) the liquid has a liquid weight; and
(b) the bag is formed of a material which is impervious to an extent whereby the bag loses no more than 0.01 percent of the liquid weight over a period of about two years.

16. An assembly as set forth in claim 10 wherein:
(a) the liquid has a liquid weight and each of the planks has a plank weight; and
(b) the liquid weight of the liquid within the bag is approximately equal to the plank weights of the planks within the bag.

17. A pre-soaked grilling plank assembly comprising:
(a) a substantially liquid impervious bag formed of a flexible polymer film;
(b) a first grilling plank and a second grilling plank positioned within the bag;
(c) a separator positioned between the planks to separate the planks within the bag;
(d) a soaking liquid positioned within the bag of a quantity to substantially immerse the planks therein, the liquid having a liquid weight;
(d) the bag having a rupturable seal to secure the planks and liquid therein and to enable selective opening of the bag to facilitate removal of a plank therefrom;
(e) a reseal structure formed within the bag to enable selective resealing of the bag after removal of one of the planks therefrom; and
(f) the bag being formed of a material which is impervious to an extent whereby the bag loses no more than 0.01 percent of the liquid weight over a period of about two years.

18. An assembly as set forth in claim 17 wherein:
(a) the separator is formed by a separator wall positioned between the planks to separate the planks within the bag.

19. An assembly as set forth in claim 17 wherein the bag has front and back walls wherein:
(a) the separator is formed by a weld line between the front wall and the back wall of the bag.

20. An assembly as set forth in claim 17 wherein:
(a) the bag is formed of a material which is impervious to an extent whereby the bag loses none of the liquid over a period of about two years.

21. A method of packaging a grilling plank comprising the steps of:
(a) providing a substantially liquid impervious bag;
(b) positioning a grilling plank within the bag;
(c) positioning a grill soaking liquid within the bag of a quantity to substantially immerse the plank therein; and
(d) providing a rupturable seal on the bag to secure the plank and liquid therein and to enable selective opening of the bag to facilitate removal of the plank therefrom.
